(19) United States
(12) Patent Application Publication
(10) Pub. No.: US 2003/0035481 A1
(43) Pub. Date: Feb. 20, 2003

(54) Method for transcoding compressed image bit stream

(75) Inventor: Cheul-Hee Hahm, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD, Suwon-city (KR)

(21) Appl. No.: 10/125,389

(22) Filed: Apr. 19, 2002

(30) Foreign Application Priority Data
Aug. 18, 2001 (KR) 2001-49812

(51) Int. Cl. H04B 1/66; H04N 7/12

(52) U.S. Cl. 375/240.16; 375/240.24; 375/240.2; 348/700; 375/240.21

(57) ABSTRACT

A method of transcoding an input image bit stream into an output image bit stream having a different bit rate. The method includes determining a cut area of an input image to be removed, cutting the input image according to the cut area, and generating an output image of the output image bit stream corresponding to the input image after the cutting. In the present method, image areas of not interest to a user are removed so as to lower the bit rate. In addition, removed bits are reassigned to concern areas so as to improve a picture quality.

### CROSS-REFERENCE TO RELATED APPLICATIONS

This application claims the benefit of Korean Application No. 2001-49812, filed Aug. 18, 2001, in the Korean Industrial Property Office, the disclosure of which is incorporated herein by reference.

### BACKGROUND OF THE INVENTION

1. Field of the Invention

The present invention relates to a method of converting a picture size and a bit rate of a compressed image bit stream, and more particularly, to a transcoding method which lowers a bit rate by removing undesired areas and improving a picture quality by reassigning removed bits to desired areas.

2. Description of the Related Art

With a rapid evolution of networks, inter-compatibility between different networks has become a very important issue. In general, gateways or Multi-point Control Units (MCUs) are used for inter-compatibility between the networks.

Gateways need to adjust the transmission rates of bits with respect to the states of networks through which the bits are transmitted. In particular, in multimedia server systems, Quality of Service (QoS) such as a bit rate is determined by negotiations between users and service providers.

After reaching an agreement, if the stored compressed image streams do not match the agreed level of QoS, the service providers convert stored compressed image bit streams to the agreed level. In most cases, the stored compressed image bit streams are converted into compressed image bit streams having a lower picture quality.

Personal Video Recorder (PVR) functions such as a simultaneous playback and recording function are also in demand by users of televisions or apparatuses which receive images through the Internet. With the PVR functions, the receiving apparatuses temporarily store received compressed image bit streams in Hard Disc Drives (HDD). Since the users want to store as many video programs as possible, a method of converting the bit rate of the compressed image bit streams is also needed with respect to the PVR functions.

Transcoders which compress image bit streams can be divided into homogeneous type transcoders which output compressed image bit streams having the same standard specifications as input compressed image bit streams, and heterogeneous type transcoders which output the compressed image bit streams having standard specifications different from those of the input compressed image bit streams. Depending on construction methods, transcoders can be also divided into open-loop type transcoders which have partial decoders, and closed-loop type transcoders which have full decoders.

FIG. 1 shows the structure of a conventional transcoder. The transcoder includes a decoder 102 which is formed with a full decoder or a partial decoder to decode an input image bit stream, and an encoder 104 which encodes the decoded result from the decoder 102 into a bit stream having a desired bit rate or specification. With a full decoder, a reproduction image that can be displayed is obtained from a decoded result of the decoder 102. With a partial decoder, a reproduction image that cannot be directly displayed, for example, an image expressed by transform coefficients in a discrete coefficient transform (DCT)-domain, is obtained. The encoder 104 generates an output image bit stream which satisfies conditions required by transform parameters.

Here, the input image bit stream and the output image bit stream may have the same standard specification, for example, MPEG-1, MPEG-2, H.261, or H.263, (i.e., as in the case of a homogeneous-type transcoder), or different standard specification, (i.e., as in the case of a heterogeneous type transcoder). Also, they may have different bit rates, picture sizes, picture types, picture rates, or picture resolutions.

A conventional method of converting the picture size for the transcoder of FIG. 1 includes filtering the bit stream in a frequency domain or a picture element domain, and downsampling the filtered signal. However, the conventional transcoding method is complex, and unnecessary information may be transmitted to a user who is not interested in a picture as a whole.

### SUMMARY OF THE INVENTION

Accordingly, it is an object of the present invention to provide an improved transcoding method which performs a conversion of a picture size and a bit rate of a compressed image bit stream more efficiently.

Additional objects and advantages of the invention will be set forth in part in the description which follows, and, in part, will be obvious from the description, or may be learned by practice of the invention.

To achieve the above and other objects of the present invention, there is provided a method of transcoding an input image bit stream into an output image bit stream having a different bit rate, the method comprising determining a cut area of an input image to be removed, cutting the input image according to the cut area determined, and generating an output image of the output image bit stream which fits to the input image after the cutting.

According to an aspect of the present invention, generating the output image of the output image bit stream comprises reassigning cut bits removed from the cut area to one of the output image and concern areas of the output image chosen by a user, so as to improve a picture quality.

### BRIEF DESCRIPTION OF THE DRAWINGS

The above and other objects and advantages of the present invention will become more apparent by describing in detail preferred embodiments thereof with reference to the accompanying drawings in which:

FIG. 1 is a block diagram of the structure of a conventional transcoder;

FIG. 2 is a flowchart of a transcoding method according to an embodiment of the present invention;

FIG. 3 is a schematic diagram of an operation which performs the transcoding method of the present invention; and

FIGS. 4A and 4B are schematic diagrams which illustrate an operation of initializing DC coefficients and motion vectors of macro blocks according to the present invention.

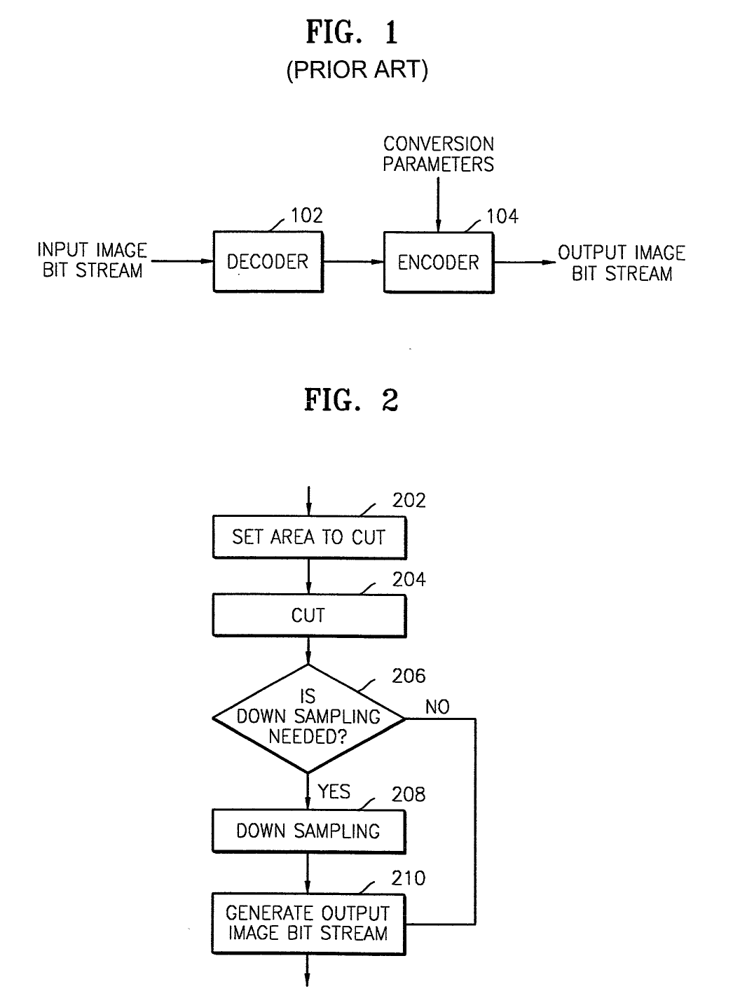

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

A method of converting a picture size and a bit rate of a compressed image bit stream of the present invention can be applied to homogeneous, heterogeneous, open-loop, and closed-loop type transcoders.

FIG. 2 shows a flowchart of a method of converting a picture size according to an embodiment of the present invention. The method includes determining a desired size of an output image (operation 202), cutting an input image according to the desired size (operation 204), determining whether a downsampling is needed (operation 206), performing the downsampling in response to a determination that the downsampling is needed (operation 208), and generating an output image bit stream (operation 210).

In operation 202, the desired size of the output image is determined. The desired size may be determined by a user, the size of a display area where an encoded area of the input image is smaller than the display area, and a trade-off between a bit rate and a picture quality. Based on the determination, a cutting area and a transcoder output area are determined.

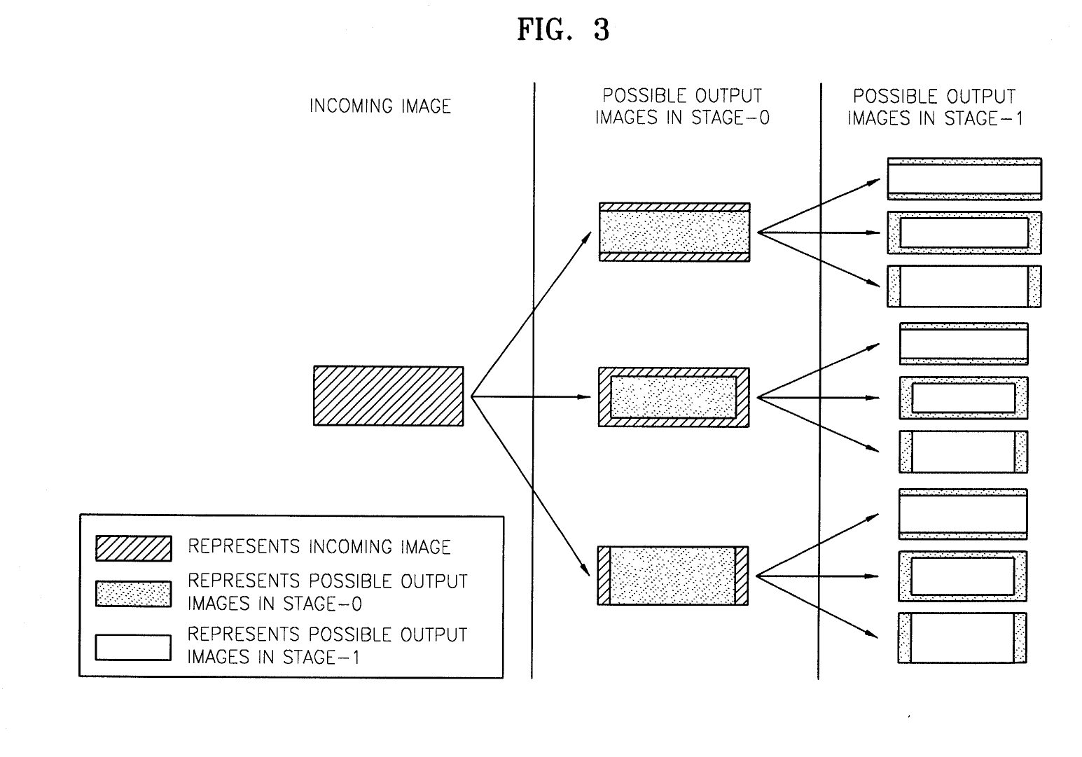

In operation 204, the determined cutting area of the input image is cut. FIG. 3 shows the possible relations between the input image and output images in a stage-0. That is, in the top image of the stage-0, top and bottom parts of the input image are cut. In the middle image of the stage-0, top, bottom, left, and right parts of the input image are cut. In the bottom image of the stage-0, left and right parts of the input image are cut. The size of the image obtained by cutting may be the same as the size of the output image of the transcoder.

In operation 206 a determination is made whether an additional downsampling is needed. In operation 208, the downsampling is performed in response to the determination that the downsampling is needed.

With the downsampling, the entire size of the picture may be reduced. Stage-1 of FIG. 3 shows the possible relations between the input images and output images with respect to the downsampling. For example, in the top images of the stage-1, images, each of which with a length reduced, are obtained. In the middle images of the stage-1, images, each of which with a length and width reduced, are obtained. In the bottom images of the stage-1, image, each of which with a width reduced are obtained.

In operation 210, using the output of operation 208, an output image bit stream of the transcoder is generated. At this time, motion vectors corresponding to an area outside of the transcoder output area determined in operation 202 should be modified. Also, in the newly defined output area, a DC coefficient of DCT coefficients and a motion vector of a first macro block in each slice (a unit of picture division) should be initialized.

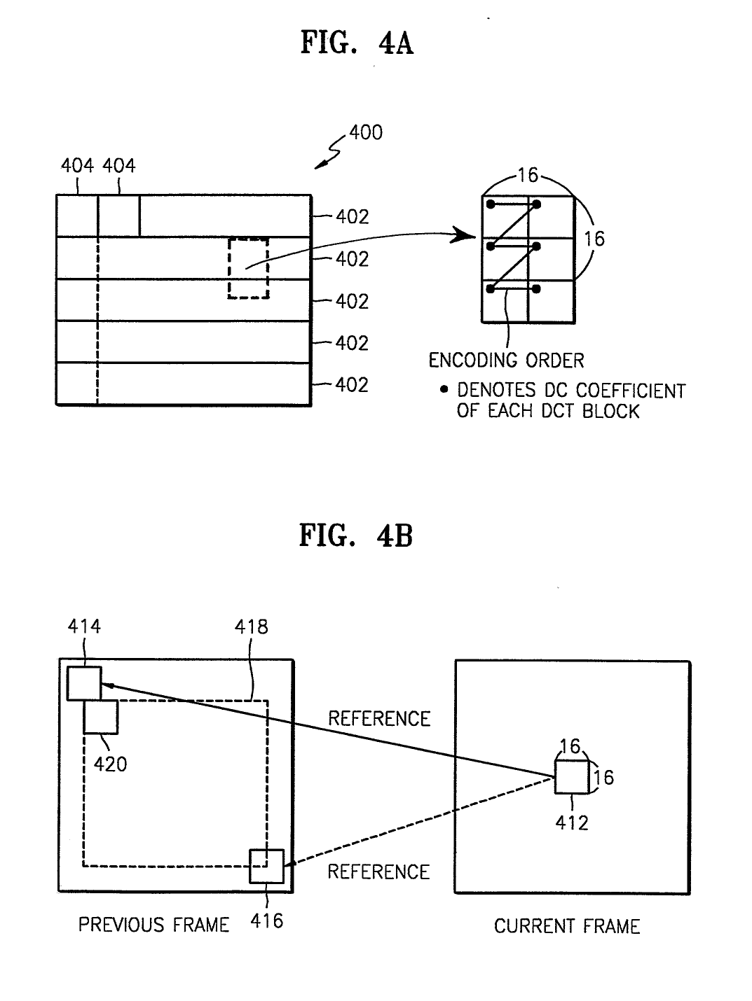

FIGS. 4A and 4B show schematic diagrams which illustrate an operation of initializing DC coefficients and motion vectors of macro blocks. As shown in FIG. 4A, a frame 400 is divided into a plurality of slices 402, each of which is formed of a plurality of macro blocks 404. A macro block is formed of, for example, four luminance signal DCT blocks and two chrominance signal DCT blocks. Each DCT block has a size of, for example, 8×8 picture elements. Also, DCT coefficients obtained by DCT transforming a DCT block is formed of, for example, one DC coefficient and 64 AC coefficients. In DCT coefficients, the DC coefficient is encoded in a differential encoding method, and the AC coefficients are encoded in a run-length method.

In differential encoding the DC coefficient, the DC coefficient of the first luminance signal DCT block of each slice is a base and the differences between the base DC coefficient and the DC coefficients of the remaining DCT blocks of each slice are encoded. Therefore, in decoding, the DC coefficient of the first luminance signal DCT block of each slice should be known.

However, where a part of the frame 400, left of the dotted line in FIG. 4A, is cut, parts corresponding to DC coefficients of the first luminance signal DCT blocks of each slice are cut, and therefore DC coefficients cannot be restored normally. Therefore, when an image is cut, initialization is performed so as to have DC coefficients of luminance signal DCT coefficients of the first macro block included in the remaining image become new bases.

As shown in FIG. 4B, the motion vector of a macro block 412 of a current frame is encoded by referring to a macro block 414 or 416 of a previous frame which is similar to the macro block 412 of the current frame. The coordinate difference between these macro blocks corresponds to the motion vector.

However, where a dotted line rectangle, that is, a remaining area 418 is left after cutting the rest of the previous frame, the macro block 414 or 416 referred to by the macro block 412 is discarded. As a result, following frames cannot be decoded normally. Therefore, when the macro block 414 or 416 to be referred to is cut, the motion vector should be adjusted again. Accordingly, an adjustment may be made where a macro block 420 nearest to the reference macro block 414 in the remaining area 418 is set as a new reference macro block.

Because the remaining area is not as small as a half or a third of the original image, the macro block 420 adjacent to the reference macro block 414 can be found in the remaining area for the setting. An assumption that the number of macro blocks, of which motion vector should be modified, is another reason for the setting.

Operations 202 through 210 may be repeated as necessary where the bit rate of the output image bit stream generated in operation 210 does not satisfy the requirements.

According to the present method of transcoding shown in FIG. 2, a bit rate can be reduced by removing areas of an image, which a user is not interested in, after setting the areas as cutting areas.

In addition, by reassigning cut bits removed from the cutting area to one of an output image and concern areas which the user is particularly interested in, an efficient transcoding having a good picture quality in the concern areas can be achieved.

As described above, areas of an image, which the user is not interested in, are removed so as to lower the bit rate. The removed bits are reassigned to the concern areas so as to provide a better picture quality than a conventional method of transcoding.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A method of transcoding an input image bit stream into an output image bit stream having a different bit rate, the method comprising:
determining a cut area of an input image to be removed;
cutting the input image according to the cut area; and
generating an output image of the output image bit stream corresponding to the input image after the cutting.

2. The method of claim 1, wherein the determining of the cut area comprises determining the cut area corresponding to a size of a display area in response to an encoded area of the input image being smaller than the display area.

3. The method of claim 1, wherein the determining of the cut area comprises determining the cut area according to a desired trade-off result between a bit rate and a picture quality.

4. The method of claim 1, wherein the generating of the output image of the output image bit stream comprises modifying a motion vector corresponding to the cut area.

5. The method of claim 1, wherein the generating of the output image of the output image bit stream comprises initializing a direct current (DC) coefficient of discrete coefficient transform (DCT) coefficients and a motion vector of a first macro block of each slice in an output area corresponding to the output image.

6. The method of claim 1, wherein the generating of the output image of the output image bit stream comprises reassigning cut bits of the cut area to one of the output image and a concern area of interest to a user, so as to improve a picture quality.

7. The method of claim 1, wherein the determining of the cut area comprises determining the cut area corresponding to a desired area set by a user.

8. The method of claim 1, further comprising downsampling the input image after the cutting in response to a determination that the downsampling is needed.

9. The method of claim 1, further comprising adjusting a motion vector of a macro block of the output image in response to the cutting of the input image according to the cut area having a reference macro block, wherein a macro block of the input image, after the cutting, nearest to the reference macro block is set as a new reference macro block.

10. The method of claim 5, wherein the initializing is performed so as to have the DC coefficient of the DCT coefficients of the first macro block of each slice included in the output image become a base portion.

11. The method of claim 1, wherein the method of transcoding is repeated until a bit rate of the output image bit stream satisfies a desired bit rate.

12. A method of changing a bit rate of a compressing image bit stream, in which the bit rate of an input image bit stream is changed to an output image bit stream having a desired bit rate, the method comprising:
determining a desired image area of an output image;
obtaining a remaining image by cutting an input image according to the desired image area; and
generating the output image of the output image bit stream corresponding to the remaining image.

13. The method of claim 12, wherein the generating of the output image comprises reassigning cut bits of image areas removed from the input image to one of the output image and a concern area determined by a user so as to improve a picture quality.

14. The method of claim 13, wherein the cutting of the input image according to the desired image area lowers the bit rate of the output image bit stream.

15. The method of claim 12, wherein the method of changing the bit rate is repeated until the bit rate of the output image bit stream satisfies the desired bit rate.

16. The method of claim 12, wherein the determining of the desired image area comprises determining the desired image area corresponding to one of a size of a display area in response to an encoded area of the input image being smaller than the display area, a desired area set by a user, and a desired trade-off result between the bit rate and a picture quality.

17. The method of claim 16, further comprising downsampling the remaining image in response to a determination that the downsampling is needed.

18. The method of claim 17, wherein the generating of the output image comprises one or a combination of:
modifying a motion vector corresponding to an area outside of the desired image area; and
initializing a direct current (DC) coefficient of discrete coefficient transform (DCT) coefficients and the motion vector of a first macro block of each slice in the remaining image.

19. The method of claim 18, wherein the initializing is performed so as to have the DC coefficient of the DCT coefficients of the first macro block of each slice included in the output image become a base portion.

20. The method of claim 17, further comprising adjusting a motion vector in response to the cutting of the image area according to the desired image area having a reference macro block, wherein a macro block of the remaining image nearest to the reference macro block is set as a new reference macro block.

21. A method of obtaining a desired bit rate of a compressed image bit stream comprising:
obtaining a remaining image area by determining a desired image area and cutting an input image of an input image bit stream according to the desired image area; and
generating an output image of an output image bit stream corresponding to the remaining image.

22. The method of claim 21, wherein the generating of the output image comprises reassigning cut bits of image areas removed from the input image to a concern area of the output image determined by a user so as to improve a picture quality.

23. The method of claim 21, wherein the cutting of the input image according to the desired image area lowers the bit rate of the output image of an output image bit stream.

24. A computer readable medium encoded with operating instructions for implementing a method of changing a bit rate of a compressing image bit stream performed by a computer, in which the bit rate of an input image bit stream is changed to an output image bit stream having a desired bit rate, the method comprising:
determining a desired image area of an output image of the output image bit stream;
obtaining a remaining image by cutting an input image of the input image bit stream according to the desired image area; and
generating the output image of the output image bit stream corresponding to the remaining image.

25. The computer readable medium of claim 24, wherein the generating of the output image comprises reassigning cut bits of image areas removed from the input image to one of the output image and a concern area determined by a user so as to improve a picture quality.

26. The computer readable medium of claim 24, wherein the determining of the desired image area comprises determining the desired image area corresponding to one of a size of a display area in response to an encoded area of the input image being smaller than the display area, a desired area set by a user, and a desired trade-off result between the bit rate and a picture quality.

27. The computer readable medium of claim 26, further comprising downsampling the remaining image in response to a determination that the downsampling is needed.

28. The computer readable medium of claim 27, wherein the generating of the output image comprises one or a combination of:
modifying a motion vector corresponding to an area outside of the desired image area; and
initializing a direct current (DC) coefficient of discrete coefficient transform (DCT) coefficients and the motion vector of a first macro block of each slice in the remaining image.

29. The computer readable medium of claim 27, further comprising adjusting a motion vector of a macro block of the output image in response to the cutting of the image area according to the desired image area having a reference macro block, wherein a macro block of the remaining image nearest to the reference macro block is set as a new reference macro block.

30. The computer readable medium of claim 24, further comprising repeating the method of changing the bit rate until the bit rate of the output image bit stream satisfies the desired bit rate.
